(19) United States
(12) Patent Application Publication
(10) Pub. No.: US 2006/0182668 A1
(43) Pub. Date: Aug. 17, 2006

(54) Multiphase polymerization reactor

(76) Inventors: Vinh N Le, LaCrosse, WI (US); Syed M Ahmed, Riyadh (SA)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/501,387

(22) PCT Filed: Dec. 31, 2002
(86) PCT No.: PCT/US02/41770

§ 371 Date: May 23, 2005

Related U.S. Application Data
(63) Continuation of application No. 10/044,714, filed on Jan. 12, 2002, now abandoned.

(51) Int. Cl. B01J 19/00; F28D 21/00

(52) U.S. Cl. 422/131; 422/198; 422/202

(57) ABSTRACT

A polymerization reactor comprises a heat pipe jacket for the removal of large heat fluxes and capable of maintaining essentially isothermal conditions without the use of complicated and maintenance intensive circulation heat exchangers or internal coils. This isothermal reactor is useful particularly when polymerization is conducted in multiphase system and/or when the rate of reaction is high and when consistent polymer properties are desired.

### BACKGROUND OF THE INVENTION

1. Field of the Invention

The present invention relates to an improved chemical reaction apparatus which is capable of removing large beat fluxes from a reaction mixture while maintaining the reaction mixture at essentially isothermal conditions. The invention also relates to a method of conducting chemical reactions, and in particular, multi-phase polymerization reactions, at essentially isothermal conditions using the novel reactor of the invention.

2. Description of Related Art

A variety of commercially important chemical reactions, and in particular manner polymerization reactions, are performed in stirred batch reactors in which maintaining the temperature of the reactants within a narrow temperature range is critical for achieving desired product properties.

Because batch reactors have a relatively low ratio of surface area to reactor volume and many chemical reactions which are commonly conducted in batch reactors generate large amounts of heat which must be quickly removed from the reaction mixture, heat transfer limitations frequently control batch reactor design. This problem is aggravated when low thermal conductivity of the reaction mixture limits heat transfer.

One prior approach to increasing the heat transfer capability of batch reactors employed cooling coils immersed in the reaction mixture. However, this approach has proved less than satisfactory because the cooling coils can be subject to fouling by viscous reaction mixtures and in particular by viscous polymers in polymerization reactions. Additionally, the presence of cooling coils in a multi-phase reaction mixture can reduce the stability of the reaction mixture. Other attempts to improve the heat transfer characteristics of batch reactors have involved withdrawing a portion of the reaction mixture and circulating it through external heat exchangers. While this approach is satisfactory for some reactions, it is less than satisfactory for many reactions and in particular reactions, with multi-phase reaction mixtures which are adversely affected by shear forces associated with circulation through an external heat exchanger.

The inability to adequately control the temperature of isothermal reactions conducted in batch reactors can result in runaway reactions, or alternatively impose the necessity of using the reaction conditions which undesirably increase batch reaction time.

The heat transfer limitations of previously known batch reactors have been particularly troublesome for polymerization reactions involving multi-phase polymer systems. For example, the inverse emulsion polymerization of acrylamide has a very fast reaction rate even at ambient temperature. Since this reaction is also highly exothermic, jacket cooling of a batch reactor is insufficient due to the limited heat transfer coefficient of a conventional jacket cooled batch reactor and due to the low temperature differential between conventional cooling water and an ambient temperature reaction mixture. Although reflux cooling provided by evaporating an intermediary liquid from the reaction mixture has the advantage of high heat transfer coefficients in reflux condensers, reflux cooling is not desirable in acrylamide and many other polymerization reactions because of the inherent difficulty in maintaining emulsion stability in the reaction mixture. This frequently obliges the use of external coolers to remove heat from a circulated portion of the reaction mixture, which imposes the aforedescribed problems of shear sensitivity, and also frequent fouling of the external heat exchanger and its circulating feed pump by polymer products.

Accordingly, a batch type reactor capable of handling high heat flux without internal cooling coils, reflux cooling and/or the circulation of the reaction mixture through an external cooler would be highly desirable with respect to many isothermal chemical reactions and in particular with respect to multi-phase polymerization reactions.

### SUMMARY OF THE INVENTION

The chemical reactor of the present invention comprises a conventional tank reactor equipped with a heat transfer device commonly referred to as a heat pipe. As described in U.S. Pat. No. 2,350,348 to Gaugler, heat pipes utilize evaporation of a cooling fluid from a porous medium affixed to a beat transfer surface to absorb heat. In the present invention, a heat pipe system is applied to the external surface of a tank reactor opposite the reaction mixture in the reactor to remove the heat of reaction from the reaction mixture by evaporative cooling through the heat transfer surface of the heat pipe. The porous medium on the heat transfer surface is commonly referred to as a “wick”. The evaporation of the cooling fluid from the porous medium enjoys extremely good heat transfer coefficients and enables extremely high heat flux at essentially isothermal conditions. The evaporated heat transfer fluid is then condensed and returned to the heat transfer zone of the reactor. Since heat transfer coefficients associated with condensation are also high, both the heat absorption and heat release segments of the heat pipe equipped reactor enjoy very high heat flux rates.

According to the present invention, a heat pipe heat transfer system is applied to the external surface of a tank reactor. A reactor so equipped can be operated in either batch or continuous mode. The reactor of the invention can be a stirred tank reactor when desirable.

The benefits of utilizing a heat pipe heat transfer device on a tank reactor as described are derived from its converting what would otherwise be a convection heat transfer to evaporative cooling. Convection heat transfer is limited by many factors which are difficult to control on tank reactors, including the velocity of the heat transfer fluid, the temperature differential between the reaction mixture and the cooling fluid, the viscosity of the heat transfer fluids, the surface area available for heat transfer, the materials of construction of the heat transfer device and the condition of the heat transfer surfaces, i.e., whether they are fouled. The heat pipe substitutes heat transfer with a phase change for convection heat transfer. Further, the heat release segment of heat pipe equipped tank reactor relies upon the condensation of the heat transfer fluid which can take place in a condenser which is remote from the reactor, so that the surface area available for cooling need not be limited to the area of the tank reactor's external surface. Accordingly, condenser(s) with sufficient surface area to handle the required heat flux can be located away from the tank reactor of the invention while still being in close proximity to it.

Because the evaporation of a pure heat transfer fluid occurs at a single temperature and the heat transfer coefficients for the heat pipe heat transfer apparatus of the present invention are very good, a tank reactor equipped with a heat pipe heat exchange device according to the present invention can be operated at essentially isothermal conditions. Because the heat transfer coefficients for evaporation are significantly higher than those for convection, especially when the heat transfer surface is porous as in the case of a heat pipe, the reactor of the present invention enjoys substantially greater heat flux than would be possible with conventional jacket cooling of a tank reactor.

The heat pipe cooled tank reactors of the present invention are suitable for emulsions, suspensions and viscous polymer syrups because they do not have internal or external circulating loops, which can cause emulsions and suspensions to lose stability and which can be fouled with viscous polymer incrustations.

Polymerization reactions conducted in multiple phase systems are particularly advantaged in the reactor of the present invention. These polymer systems can be solutions of polymer or co-polymers and their respective monomers suspended in water (emulsion and suspension polymerization), solutions of polymers and their monomers in water suspended in oils (inverse emulsion and suspension polymerization) and many other possibilities.

Examples of monomers or co-monomers which can be advantageously polymerized to their corresponding polymers in the reactor of the invention are:

Ethylene (PE)

Propylene (PP)

Styrene (PS, ABS, SAN, SBS)

Butadiene (PBR)

Acrylonitrile (PAN)

Vinyl chloride (PVC)

Acrylamide, methacrylamide and their derivatives

Dimethyl Terephtalate (PET)

Terephtalic acid (PET)

Methyl Methacrylate (PMMA)

Caprolactam (PA)

Naphtalene Dicarboxylate (PEN)

Maleic anhydride (SMA)

When the above and other polymerization reactions are conducted in the reactor of the invention, the process surface is not subject to fouling because the reactor temperature is uniform since the evaporation and condensation of the heat transfer fluid occurs at the same uniform temperature, and cold and hot spots in the reactor are avoided.

As described by Faghri (“Heat Pipe Science and Technology”, Taylor and Francis, 1995) and by Peterson (“An Introduction to Heat Pipes”, John Wesley & Sons, 1994), the choice of the material of construction, the choice of the internal working fluid and the design of the wick structure for the heat pipe apparatus of the invention is within the capability of those skilled in the art. The materials of construction in contact with the heat transfer fluid are commonly selected from copper and copper alloys, aluminum and its alloys and stainless steel and other ferrous metal alloys.

Although the term heat “pipe” and “tank” reactor are used in the description of this invention, innumerable configurations are possible, some of which are far from the cylindrical shape of a conventional pipe or tank. For example, possible shapes could be, but not limited to, flat, rectangular, annular, polygonal or tubular.

The isothermal chemical reactors of the present invention can utilize either sealed or thermosyphon heat pipe heat transfer devices.

The sealed heat pipe is comprised of three sections: (1) an evaporator section where heat is absorbed by vaporizing a liquid beat transfer medium, (2) an adiabatic section where the vaporized heat transfer medium flows without changing state, and (3) the condenser section where the vaporized heat transfer medium is condensed using an external source of cooling. The heat transfer medium condensate returns to the evaporator section by the wicking action of the porous surface or wick in the evaporator section. Because wicking is a surface tension phenomenon that may be limited in long heat pipes by liquid head, if a particular reaction would require a reactor in which the reaction mixture would occupy a reaction zone having a large vertical dimension, it is sometimes preferred to operate the reactor of the invention with the heat pipe heat transfer device in a horizontal position. Alternatively, a large vertical reaction zone can be divided into multiple heat pipe heat transfer zones each having height and a corresponding wick height which can be wetted by capillary action of the heat transfer fluid in the wick.

The thermosyphon heat pipe embodiment of the invention can utilize gravity or pumps to return condensed heat transfer fluid to the evaporator section through piping which is distinct from that used to convey vaporized heat transfer fluid from the evaporator section of heat pipe to the condenser. In the thermosyphon heat pipe embodiment of the invention, a source of liquid heat transfer fluid, which advantageously can be clean boiler feed water can feed the evaporator section of the reactor heat pipe and the evaporator section can communicate with a vapor header, such as a steam header. In this way, the thermosyphon heat pipe reactor of the invention can be used to generate useful steam from reactor waste beat and eliminate the need for reactor coolers/condensers.

In the case of both the sealed heat pipe and thermosyphon heat pipe reactors of the invention, reaction temperature is regulated by the boiling point of the heat transfer fluid. By varying the pressure of the heat transfer fluid, it is possible to vary the boiling point of the beat transfer fluid. In many cases the temperature over the entire reactor can be controlled to within 1 degree centigrade.

Despite the fact that the heat pipe reactor of the present invention adds intermediary steps to the overall heat transfer mechanism, the heat transfer flux of the reactor surface can be enhanced by several orders of magnitude over conventional convection cooling. The fast rate of heat transfer with fluid evaporation on a porous surface and the rapid transport of the vapors from the evaporator section to the condenser section of the heat pipe contribute to this superior performance.

In the reactor of the invention, the beat transfer fluid is chosen to assure trouble free heat pipe operation depending on the temperature of operation. It can be selected from liquids having the desired boiling point at a selected operating pressure. Common heat transfer fluids are water, acetone, alkanes, ammonia, fluorocarbons and aromatic solvents.

The wick utilized in the invention can be comprised of fiber mats, sintered metal powders of single size or multiple sizes of spherical or non-spherical shape, and metal screens in single or multiple layers.

### BRIEF DESCRIPTION OF THE DRAWINGS

Specific embodiments of the present invention will now be described further, by way of example, with reference to the accompanying drawings, in which:

FIG. 1 illustrates a perspective view of a reactor according to the invention having multiple sealed heat pipe heat transfer devices of the pipe jacket type.

FIG. 2 illustrates a perspective view of a reactor according to ihe invention having multiple thermosyphon beat pipe heat transfer devices of the pipe jacket type with individual condensers.

### DETAIL DESCRIPTION OF THE INVENTION

Chemical reactors with heat pipe heat transfer devices and methods of using such devices to perform chemical reactions are disclosed. In the following detailed description of the invention, for purposes of explanation, specific features, materials, dimensions and the like may be set forth to provide a thorough understanding of the present invention. However, it will be apparent to those skilled in the art that the present invention may be practiced without these specific details. In some instances, well known devices are shown in block diagram form not to obscure the invention unnecessarily.

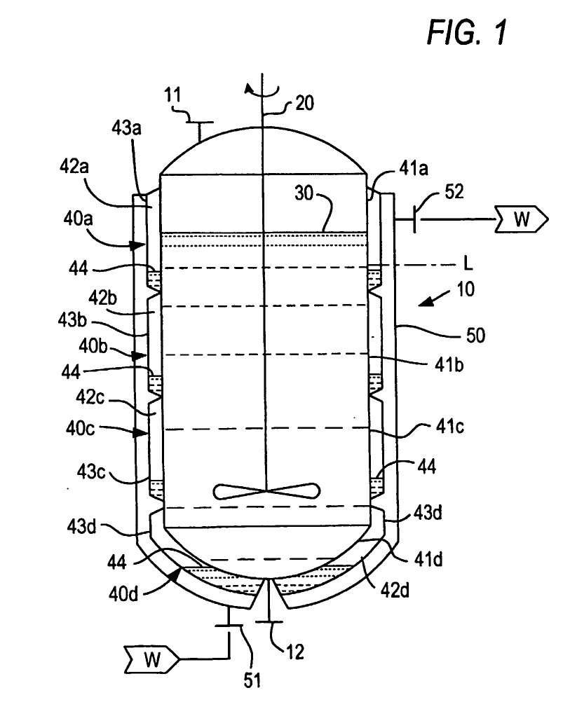

With reference to FIG. 1, a preferred embodiment of a reactor 10 constructed according to the present invention is illustrated. In FIG. 1, reactor 10 is equipped with feed nozzle 11, outlet 12 and stirring device 20. In operation, reactor 10 is filed with reaction mixture 30 comprised of reactants and reaction products, the relative concentrations of which will vary as the selected reaction proceeds. Reaction mixture 30 fills reactor 10 to level L. Reactor 10 is equipped with annular jacket type heat pipe units 40a-d. Heat pipe units 40a-d, respectively each have wicked reactor wall heat transfer surfaces 41a-d; annular spaces 42a-d, and condenser heat transfer surfaces 43a-d. Heat transfer fluid 44 is in annular spaces 42a-d. Heat transfer fluid 44 is in the liquid phase at the bottom of annular spaces 42a-d and is the vapor phase in the balance of annular spaces 42a-d. Cooling liquid jacket 50 surrounds heat pipe heat transfer units 40a-d. Cooling liquid W is fed into cooling liquid jacket 50 at cooling jacket inlet 51 and flows from jacket 50 at cooling jacket outlet 52.

In operation, reactor 10 is filled with reaction mixture 30 comprised of the chemical compounds to be reacted. Optionally reaction mixture 30 can include one or more catalysts. Reactor 10 is stirred using stirring device 20. Reaction mixture 30 is at a temperature selected to encourage the reaction of the reactants to one or more desirable products. Because the reaction of the reactants to the desired product is isothermic, means must be provided to remove the heat of reaction.

The heat of reaction from reaction mixture 30 flows through the walls of reactor 10 to wicked reactor wall heat transfer surfaces 41a-d. Wicked reactor wall heat transfer surfaces 41a-d are wetted with heat transfer fluid 44 from a pool of fluid 44 at the bottom of annular spaces 42a-d. The heat transfer fluid 44 has a boiling point which is essentially the same as the desired reaction temperature for reaction mixture 30.

The height of heat pipe heat transfer units 40a-d is selected so that the capillary action of wicked reactor wall heat transfer surfaces 41a-d is sufficient to overcome the liquid head created by the wetting of wicked reactor wall heat transfer surfaces 41a-d. The heat of reaction from reaction mixture 30 causes heat transfer fluid 44 to vaporize in wicked reactor wall heat transfer surfaces 41a-d and thereby absorb the heat of reaction. Vaporized heat transfer fluid 44 flows through annular spaces 42a-d until it comes in contact with condenser heat transfer surfaces 43a-d. Vaporized heat transfer fluid 44 condenses on condenser heat transfer surfaces 43a-d and releases the heat of reaction to condenser heat transfer surfaces 43a-d, through which the heat of reaction flows to cooling liquid W in cooling liquid jacket 50. Cooling liquid W which may be cooling water, is sent to cooling liquid recovery where its temperature is reduced to a predetermined temperature for cooling liquid feed.

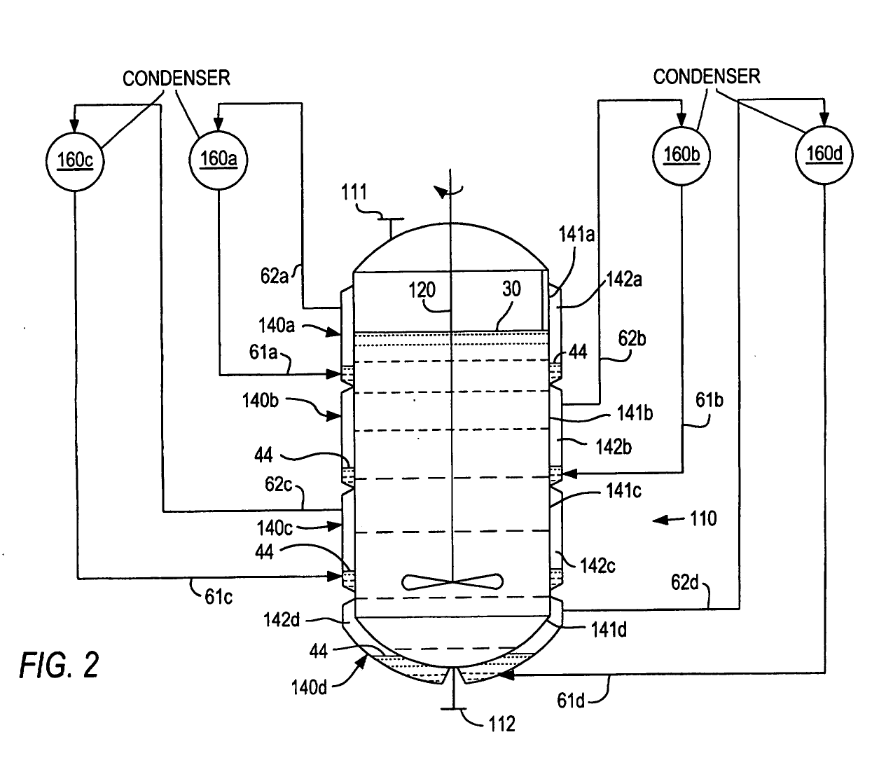

With reference to FIG. 2, a preferred embodiment of the reactor of the invention having multiple thermosyphon heat pipe heat transfer devices with individual condensers is illustrated. Components in FIG. 2 which operationally correspond to components in FIG. 1, either bear the same number as FIG. 1 or the same number plus 100.

In FIG. 2, reactor 110 differs from the reactor depicted in FIG. 1 by the substitution of thermosyphon heat pipe units 140a-d for the sealed heat pipe heat units 40 of FIG. 1. Thermosyphon heat pipe units 140a-d, respectively have wicked reactor wall heat transfer surfaces 141a-d, and annular spaces 142a-d. Thermosyphon heat pipe units 140a-d have vapor outlet lines 62a-d at their upper ends which communicate with, respectively, condensers 60a-d. Vaporized heat transfer fluid 44 flows through annular spaces 142a-d and vapor outlet lines 62a-d to condensers 60a-d. Heat transfer fluid 44 is in the liquid phase at the bottom of annular spaces 142a-d and is conveyed by capillary action into wicked reactor wall heat transfer surfaces 141a-d.

The heat of reaction from reaction mixture 30 flows through the walls of reactor 110 to wicked reactor wall heat transfer surfaces 140a-d. The heat of reaction causes heat transfer fluid 44 to vaporize and flow through vapor outlet lines 62a-d to condensers 60a-d, wherein evaporated heat transfer fluid 44 is condensed in conventional fashion using cooling water or other heat transfer means. Condensed heat transfer fluid 44 is returned by gravity or pumping through heat pipe feed lines 61a-d to thermosyphon heat pipe units 140a-d.

### EXAMPLES

The following examples illustrate the efficacy of the heat pipe reactors of the invention to maintain isothermal conditions in chemical, and especially polymerization, reactions as compared with conventional liquid cooled jackets.

The inverse emulsion/suspension polymerization of acrylamide is commonly conducted in batch mode. Acrylamide polymerization proceeds at a very fast rate even at the ambient temperature of 25° C., therefore requiring efficient heat transfer equipment. The reaction is also highly exothermic.

Acrylamide is soluble in water but not in organic liquids such as C5-C14 alkanes. Polyacrylamide forms a gel in water. This polymer gel is suspended in alkane for ease of handling. It is undesirable to cool the acrylamide/polyacrylamide reactant/product mixture by circulating the process fluid through an external heat exchanger because of the possibility of fouling the heat exchanger with the polymer gel. Direct reflux cooling through the evaporation of water (which is more volatile than the alkane) is not considered because (a) the low temperature would require the reactor to operate under vacuum and (b) the returned reflux (water) would create a third phase in the reactor. Therefore the necessity of handling high heat release usually limits the acrylamide/polymerization to relatively small batches. Since the surface to volume ratio of a reactor increases with decreasing batch size, small reactors have higher heat flux capacity per unit volume than larger reactors.

If a 60 m³ batch reactor is used to produce a polyacrylamide, the reactor dimensions are 12 ft ID by 18 ft long. Such a batch reaction mixture consists of 20,000 kg of water, 20,000 kg of acrylamide and 20,000 kg of hexane. The reaction temperature is 25° C. and the batch time is 3 hours. The density of all components is assumed to be 1000 kg/m³. The heat of reaction is 2,140 kW. It is also assumed that chilled water at 15° C. is available to remove the beat of reaction.

If the described reactor were to be cooled with forced circulation of water through a conventional cooling jacket, the maximum heat duty of the jacket would be approximately 520 kW in the 3 hours reaction time. Since this is only ¼ of the required heat removal, a conventionally cooled batch reactor would have to be much smaller to maintain isothermal reaction conditions.

If the sealed heat pipe reactor depicted in FIG. 1 is used for the reaction, heat pipe jackets 40a-d would preferably be made of copper. Conventional water jacket 50 surrounds heat pipe jackets 40a-d. The maximum heat removal capacity of this embodiment of the invention is approximately 900 kW which is 73% greater than the conventionally cooled reactor. Nevertheless, the heat removal capacity of this embodiment of the invention is also less than is required for reactor of the size proposed.

The batch reactor of FIG. 2 with multiple thermosyphon heat pipe jackets 140 with individual condensers 60 can also be applied to the instant reaction. However, because of liquid head limitations in heat transfer units 140, seven such units are required on the shell of the reaction and one for the bottom head of the reactor.

The average heat flux in the thermosyphon heat pipe units is approximately 29 kW/m². Since the total beat transfer average of the thermosyphon heat pipe units 140 is approximately 75 m², the reactor of FIG. 2 has sufficient heat transfer capacity to handle the beat of reaction for the 60 m³ batch reactor. Since the heat transfer area of condensers 70 is not limited to the available reactor jacket surface, a total of approximately 180 m² of condenser surface can be provided to handle the necessary heat flux.

The foregoing demonstrates that both of the described embodiments of the invention are significantly superior to conventional batch reactors in handling highly exothermic reactions at isothermal conditions.

The above description of the invention is intended to be illustrative and not limiting. Various changes or modifications in the embodiments described may occur to those skilled in the art. These can be made without departing from the spirit or scope of the invention.

We claim:

1. A reactor for conducting exothermic chemical reactions at substantially isothermal conditions comprising:
a tank reaction vessel having an interior volume for containing an exothermic reaction mixture, thermally conductive reaction vessel walls defining the interior volume of said tank reaction vessel, said thermally conductive reaction vessel walls having an exterior reaction vessel wall surface; and
at least one heat pipe heat transfer device attached to said exterior reaction vessel wall surface.

2. The reactor for conducting exothermic chemical reactions at substantially isothermal conditions of claim 1, wherein said heat pipe heat transfer unit is a sealed heat pipe.

3. The reactor for conducting exothermic chemical reactions at substantially isothermal conditions of claim 2, wherein said sealed heat pipe is contained within a jacket-type cooler.

4. The reactor for conducting exothermic chemical reactions at substantially isothermal conditions of claim 3, wherein said heat pipe heat transfer unit at least substantially circumscribes said tank reaction vessel.

5. The reactor for conducting exothermic chemical reactions at substantially isothermal conditions of claim 2, wherein said sealed heat pipe is contained in a jacket-type cooler.

6. The reactor for conducting exothermic chemical reactions at substantially isothermal conditions of claim 5, wherein said tank reaction vessel is a batch or a continuous reactor.

7. The reactor for conducting exothermic chemical reactions at substantially isothermal conditions of claim 1, wherein said heat pipe heat transfer unit is a thermosyphon heat pipe in fluid communication with a condenser which is not contained within said thermosyphon heat transfer device.

8. The reactor for conducting exothermic chemical reactions at substantially isothermal conditions of claim 7, wherein said condenser has a condensate line in fluid communication with said thermosyphon beat pipe unit.
